(19) United States
(12) Patent Application Publication
(10) Pub. No.: US 2011/0039187 A1
(43) Pub. Date: Feb. 17, 2011

(54) Manufacturing Method of Solid Oxide Fuel Cell

(75) Inventors: Joongmyeon Bae, Daejeon (KR); Seung-Wook Baek, Daejeon (KR)

Correspondence Address: THE WEBB LAW FIRM, P.C., 700 KOPPERS BUILDING, 436 SEVENTH AVENUE, PITTSBURGH, PA, 15219, US

(73) Assignee: KOREA ADVANCED INSTITUTE OF SCIENCE AND TECHNOLOGY, Daejeon (KR)

(21) Appl. No.: 12/693,132

(22) Filed: Jan. 25, 2010

(30) Foreign Application Priority Data
Aug. 14, 2009 (KR) 10-2009-0074965

(51) Int. Cl. H01M 8/10

(52) U.S. Cl. 429/497; 429/535

(57) ABSTRACT

Provided is a manufacturing method of a disc type solid oxide fuel cell; and, more particularly, to a manufacturing method of a disc type solid oxide fuel cell, in which each element is stacked on a supporting member, thereby improving stacking efficiency and also reducing a size of the fuel cell, and in which a unit cell is sinter-bonded with a metal supporter and the metal supporter is welded to a separating plate, thereby improving durability and sealing ability.

### CROSS-REFERENCE(S) TO RELATED APPLICATIONS

The present invention claims priority of Korean Patent Application No. 10-2009-0074965, filed on 14 Aug. 2009, which is incorporated herein by reference.

### BACKGROUND OF THE INVENTION

1. Field of the Invention

The present invention relates to a manufacturing method of a solid oxide fuel cell; and, more particularly, to a manufacturing method of a solid oxide fuel cell, in which each element is stacked on a supporting member, thereby improving stacking efficiency and also reducing a size of the fuel cell, and in which a unit cell is sinter-bonded with a metal supporter and the metal supporter is welded to a separating plate, thereby improving durability and sealing ability.

2. Description of Related Art

A fuel cell, which is a cell directly converting chemical energy produced by oxidation into electrical energy, is a new next-generation eco-friendly energy technology generating electrical energy from materials abundantly existing on earth, such as hydrogen, oxygen.

In the fuel cell, oxygen is supplied to a cathode and hydrogen is supplied to an anode so as to perform electrochemical reaction in the form of a reverse reaction of electrolysis of water, thereby producing electricity, heat, and water. As a result, the fuel cell produces electrical energy at high efficiency without leading to pollution.

Such a fuel cell has various advantages that it is free from a limitation of Carnot Cycle acting as a limit in a conventional heat engine so that its efficiency is increased above 40%, it discharges only water as the discharge materials as described above so that there is no a risk of pollution, and it does not need mechanically moving parts so that it is compacted and does not generate noise, or the like. Therefore, various technologies and studies associated with the fuel cell have actively been progressed.

Six kinds of fuel cells, such as a phosphoric acid fuel cell (PAFC), a molten carbonate fuel cell (MCFC), a solid oxide fuel cell (SOFC), a polymer electrolyte membrane fuel cell (PEMFC), a direct methanol fuel cell (DMFC), and an alkaline fuel cell (AFC) according to kinds of electrolytes have been put to practical use or has been in contemplation. Features of each fuel cell are arranged in the following table.

| | | | | | | |
|---|---|---|---|---|---|---|
| Division | PAFC | MCFC | SOFC | PEMFC | DMFC | AFC |
| Electrolyte | Phosphoric | Lithium | Zirconia/ | Hydrogen | Hydrogen | Potassium |
| | acid | carbonate/ | ceria | Ion | Ion | hydroxide |
| | | Potassium | | exchange | exchange | |
| | | carbonate | | Membrane | Membrane | |
| Ion | Proton | Carbonate | Oxygen | Proton | Proton | Proton |
| conductor | | ion | ion | | | |
| Operating | 200 | 650 | 500-1000 | <100 | <100 | <100 |
| temperature | | | | | | |
| (° C.) | | | | | | |
| Fuel | Hydrogen | Hydrogen, | Hydrogen, | Hydrogen | Methanol | Hydrogen |
| | | Carbon | Carbon | | | |
| | | monoxide | monoxide, | | | |
| | | | hydrocarbon | | | |
| Fuel raw | City gas, | City gas, | City gas, | Methanol, | Methanol | Hydrogen |
| material | LPG | LPG, Coal | LPG, | methane | | |
| | | | Hydrogen | gasoline, | | |
| | | | | Hydrogen | | |
| Efficiency(%) | 40 | 45 | 45 | 45 | 30 | 40 |
| Output | 100-5000 | 1000-1000000 | 1000-100000 | 1-10000 | 1-100 | 1-100 |
| range(W) | | | | | | |
| Main use | Distributed | Large | Small. | Power for | Portable | Power |
| | generation | scale | Medium, | transportation | power | supply |
| | type | generation | and Large | | supply | for |
| | | | scale | | | Spaceship |
| | | | generation | | | |
| Development | Verification- | Test- | Test- | Test- | Test- | Application |
| stage | commercialization | verification | verification | verification | verification | to |
| | | | | | | spaceship |

As appreciated from the table, each fuel cell has various output ranges and uses, etc. so that suitable fuel cells can be selected according to an object. Among them, since the solid oxide fuel cell (SOFC) has advantages in that there is no danger of an exhaustion of an electrolyte because a position of the electrolyte is easily controlled and the position of the electrolyte is fixed and also it has a long life span due to low corrosiveness, as compared to other fuel cells, the effective value of the SOFC is very large in that it is applicable to distributed generation, commerce and home use.

Reviewing the concept view of the operating principle of the SOFC, oxygen is supplied to the cathode and hydrogen is supplied to the anode. At this time, the reaction depends on the following formula.

2H₂+2O²⁻→2H₂O+4e⁻ Anode reaction

O₂+4e⁻→2O²⁻ Cathode reaction

In the SOFC, typically, yttria-stabilized zirconia (YSZ) is used as the electrolyte, a Ni—YSZ cermet is used as the cathode, a perovskite material is used as the anode and oxygen ions are used as mobile ions.

FIG. 1 is a schematic view of a conventional solid oxide fuel cell (SOFC). The conventional SOFC 1 includes a unit cell 10 having an electrolyte layer 11, an anode 12 and an cathode 13 which are formed at both sides of the electrolyte layer 11; a current collecting member 20 which is provided at both sides of the unit cell 10; and a separation plate 30a, 30b in which the unit cell 10 and the current collecting member 20 are provided.

The separation plate 30a, 30b supports the unit cell 10 and the current collecting member 20 and, at the same time, has a supplying passage 31a, 31b for supplying fuel gas and air (oxygen).

Meanwhile, in the SOFC 1, the fuel gas and air has to be flowed through only a predetermined path. If the fuel gas and air are mixed with each other or leaked to an outside, the performance of the cell is considerably deteriorated. Therefore, a high level of sealing technology is required.

However, in the conventional SOFC, a glass-based sealant 40 is used in bonding between the separation plates 30a and 30b and bonding between the unit cell 10 and the separation plates 30a and 30b. (FIG. 1 shows an example that a cathode 13 side of the unit cell 10 is bonded with the upper separation plate 30b using the sealant 40).

However, since the glass-based sealant 40 is easily broken by an external impact, it is difficult to have a sufficient strength. Also, since the glass-based sealant 40 is easily deformed by repeated changes in temperature, it is difficult to obtain a sufficient sealing performance. These problems are major causes for the performance deterioration of the SOFC 1.

Further, the current collecting member 20 is provided between the unit cell 10 and the separation plate 30a, 30b so as to enhance an electrical performance, and formed into a mesh formed of a metal alloy or a noble metal. The current collecting member 20 functions to uniformly supply the fuel gas and air to the unit cell 10. However, sealing ability is deteriorated due to the mesh type current collecting member 20, and current collecting efficiency is also lowered.

Meanwhile, only a signal unit cell module is not sufficient to obtain an enough voltage, and thus it is necessary to increase a surface area of the unit cell 10, or if necessary, multiple unit cells are stacked and then used. However, in this case, it is difficult to satisfy required mechanical strength and enough sealing feature.

### SUMMARY OF THE INVENTION

An embodiment of the present invention is directed to providing a manufacturing method of a solid oxide fuel cell (SOFC), in which a center portion of each construction element is hollowed, and which is stacked by using a separate supporting member, thereby reducing a size of the fuel cell and facilely stacking the fuel cells.

Another embodiment of the present invention is directed to providing a manufacturing method of a solid oxide fuel cell (SOFC), in which each construction element has a circular shape in section, and a unit cell is sinter-bonded with a metal supporter, thereby increasing a sealing efficiency and providing a sufficient mechanical strength.

To achieve the object of the present invention, a manufacturing method of a disc type solid oxide fuel cell (SOFC), including: forming an electrolyte layer 110 and an anode 120 which forms a unit cell 100; forming a cathode 130, which forms the unit cell 100, at one side of the electrolyte layer 110 that the anode 120 is not formed; and stacking and assembling the unit cell 100, a first current collecting member 310 provided at a cathode side of the unit cell 100, and a separation plate 400 which is provided at an anode 120 side of the unit cell 100 and has a separation plate 400 formed with a passage 410, wherein the unit cell 100, the first current collecting member 310 and the separation plate 400 are hollowed at center portions thereof and inserted onto a supporting member 500.

Preferably, the manufacturing method further includes fixing the metal supporter 200 to the anode 120 between the forming of the electrolyte layer 110 and the anode 120 and the forming of the cathode 130, and fixing a side of the metal supporter 200 that the unit cell 100 is fixed and a circumference of the side of the separation plate 400 that the passage 410 is formed between the forming of the cathode 130 and the stacking and assembling.

Preferably, the separation plate 400, the metal supporter 200, the unit cell 100 and the first current collecting member 310 have a circular shape in section, and the metal supporter 200 has a hollowed portion 210 so that the passage 410 of the separation plate 400 and the unit cell 100 are communicated with each other.

Preferably, the supporting member 500 has first and second paths 510 and 520 formed in a length direction, and the first and second paths 510 and 520 have first and second communicating portion 511 and 512 formed in a transverse direction so as to be communicated with the passage 410 of the separation plate 400. And the separation plate 400 has inlet and outlet portions 411 and 412 which are connected with the first and second communicating portions 511 and 512.

Preferably, the anode 120 and the metal supporter 200 are sinter-bonded using a bonding material 600 in the fixing of the metal supporter 200. And the fixing of the metal supporter 200 includes coating a first bonding material 810 at one side of the metal supporter 200; draying the metal supporter 200 coated with the first bonding material 810; coating a second bonding material 820 at one side of the anode 120; and closely contacting and sinter-contacting a side of the metal supporter 200 that the first bonding material 810 is coated and a side of the anode 120 on which the second bonding material 820 is coated.

Preferably, the fixing of the metal supporter 200 and the separation plate 400 is performed after a second current collecting member 320 is provided between the metal supporter 200 and the separation plate 400.

Preferably, the separation plate 400, the metal supporter 200, the unit cell 100 and the first current collecting member 310 are repeatedly stacked, in turn, in the assembling of them. And the assembling of the separation plate 400, the metal supporter 200, the unit cell 100 and the first current collecting member 310 in turn comprises: stacking the separation plate 400, the metal supporter 200, the unit cell 100 and the first current collecting member 310; sealing a hollowed region, which is formed at an upper side of the first current collecting member 310 to be contacted with the supporting member 500, using a sealing material 710; and fixing the separation plate 400, the metal supporter 200, the unit cell 100 and the first current collecting member 310, wherein the stacking and the sealing are repeatedly performed according to the number of stackings.

Preferably, a sealing disc 720 is further provided in the stacking of the assembling.

Preferably, an internally stepped portion 413 is formed at a lower side of the separation plate 400 to be adjacent to a hollowed region, thereby receiving a volume of the sealing material 710.

The present invention provides a disc type SOFC manufacture by the manufacturing method as described above.

Preferably, fuel introduced through the first path 510 and the first communicating portion 511 of the supporting member 500 and the inlet portion 411 of the separation plate 400 is flowed along the passage 410, and then discharged through the outlet portion 412 of the separation plate 400 and the second communicating portion 512 and the second path 520 of the supporting member 500, and air is supplied from an outside.

### BRIEF DESCRIPTION OF THE DRAWINGS

FIG. 1 is a schematic view of a conventional disc type solid oxide fuel cell (SOFC).

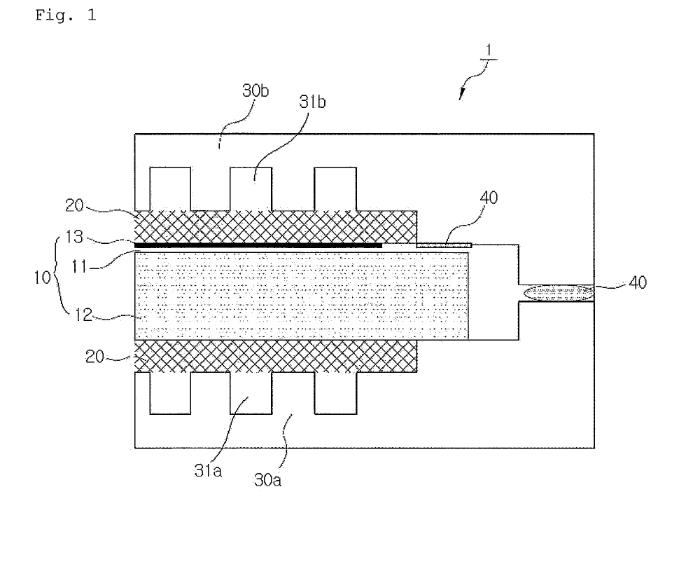

FIG. 2 is a flow chart showing steps in a manufacturing method of a disc type solid oxide fuel cell (SOFC) in accordance with the present invention.

FIG. 3 is a flow chart showing other steps in the manufacturing method of the disc type SOFC in accordance with the present invention.

FIG. 4 is a view showing a fixing step of a metal supporter in the manufacturing method of the disc type SOFC in accordance with the present invention.

FIGS. 5 and 6 are a flow chart and a view showing the fixing step of the metal supporter in the manufacturing method of the disc type SOFC in accordance with the present invention.

FIG. 7 is a view showing a fixing step of a metal supporter and a separation plate in the manufacturing method of the disc type SOFC in accordance with the present invention.

FIGS. 8 to 10 are a perspective view, an exploded perspective view and a cross-sectional perspective view a disc type SOFC in accordance with the present invention.

FIG. 11 is a view of a metal supporter of the disc type SOFC in accordance with the present invention.

FIG. 12 is a view of a separation plate of the disc type SOFC in accordance with the present invention.

FIG. 13 is a view of a supporting member of the disc type SOFC in accordance with the present invention.

FIG. 14 is a view illustrating a flow of fuel or air in the disc type SOFC in accordance with the present invention.

FIG. 15 is another perspective view showing the disc type SOFC in accordance with the present invention.

FIG. 16 is a flow chart showing an assembling step in the manufacturing method of the disc type SOFC in accordance with the present invention.

FIG. 17 is another perspective view showing the disc type SOFC in accordance with the present invention.

[Detailed Description of Main Elements]

| | |
|---|---|
| 1000: disc type solid oxide fuel cell | |
| 100: unit cell | 110: electrolyte layer |
| 120: anode | 130: cathode |
| 200: metal supporter | 210: hollowed portion |
| 310: first current collecting member | |
| 320: second current collecting member | |
| 400: separation plate | 410: passage |
| 411: inlet portion | 412: outlet portion |
| 413: stepped portion | |
| 500: supporting member | 510: first path |
| 511: first communicating portion | |
| 520: second path | |
| 521: second communicating portion | |
| 600: bonding material | |
| 710: sealing material | 720: sealing disc |
| 810: first bonding material | |
| 820: second bonding material | |
| S100~S330: each step in a manufacturing | |
| method of a disc type SOFC | |

### DESCRIPTION OF SPECIFIC EMBODIMENTS

The advantages, features and aspects of the invention will become apparent from the following description of the embodiments with reference to the accompanying drawings, which is set forth hereinafter.

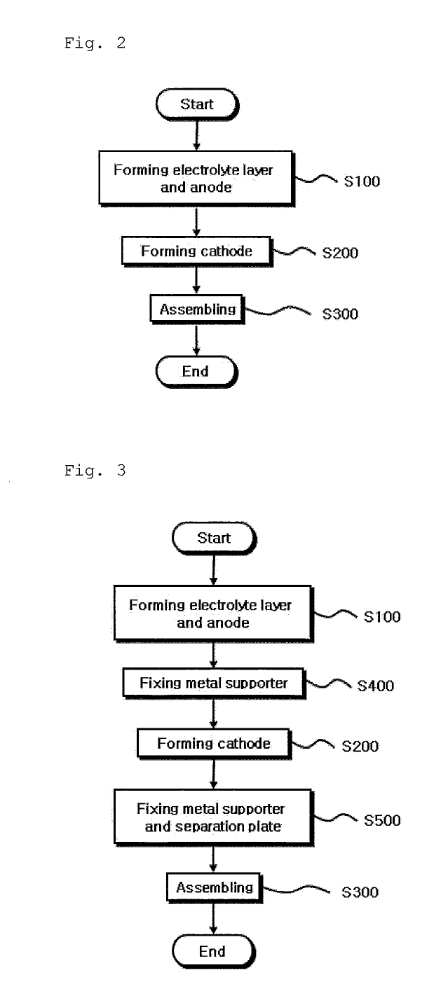

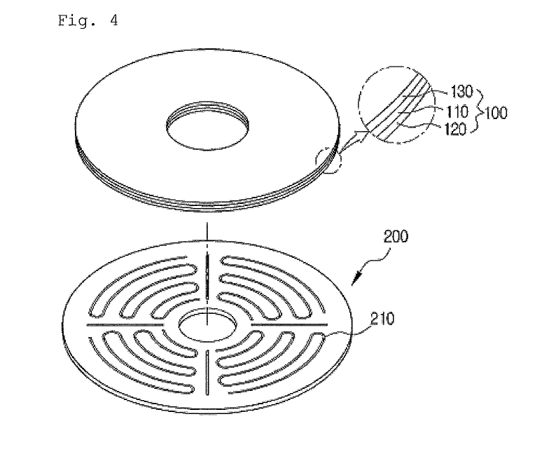

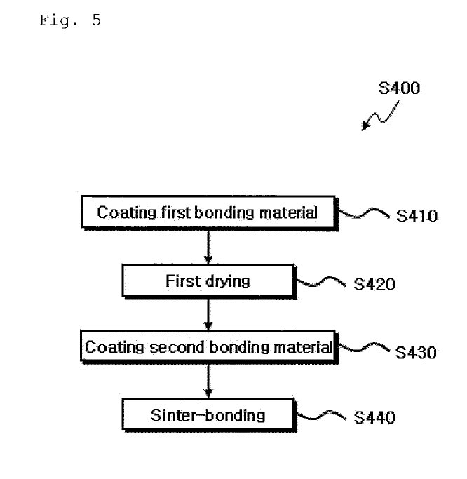

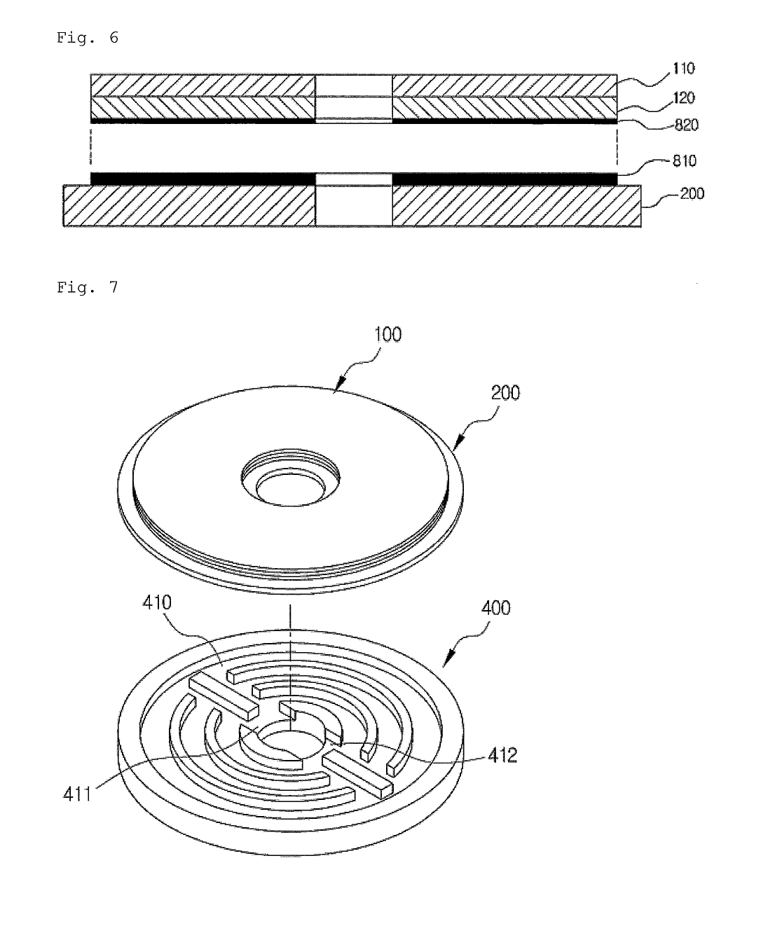

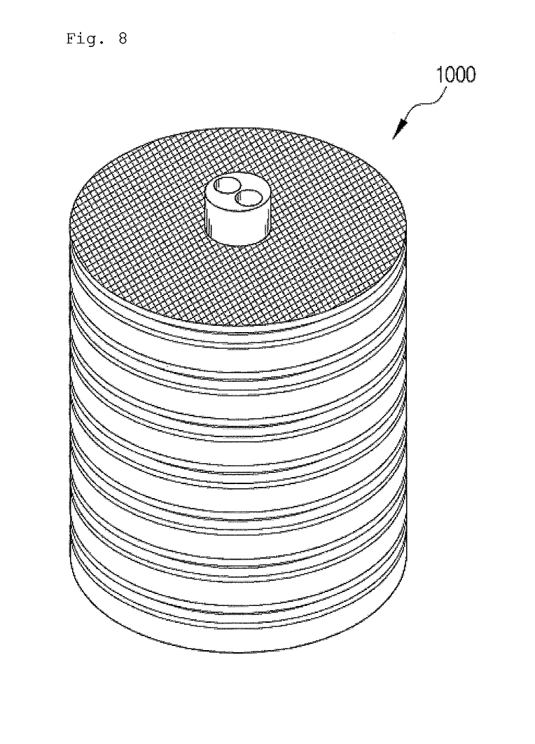

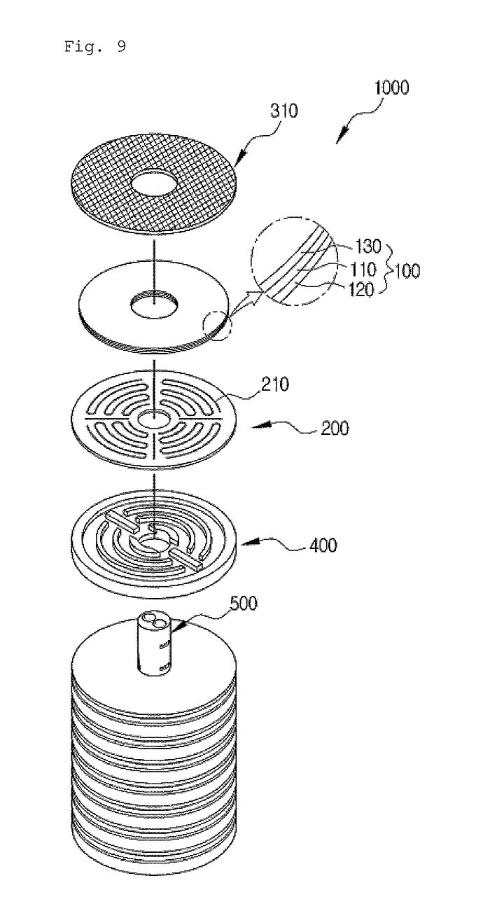

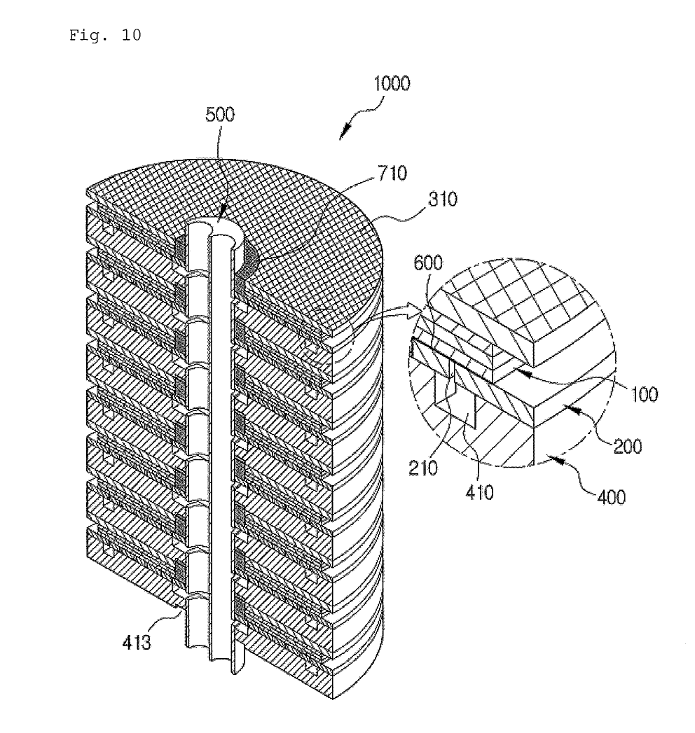

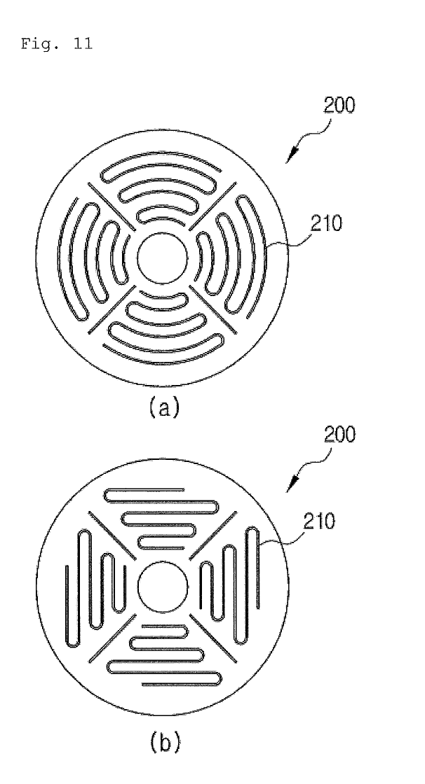

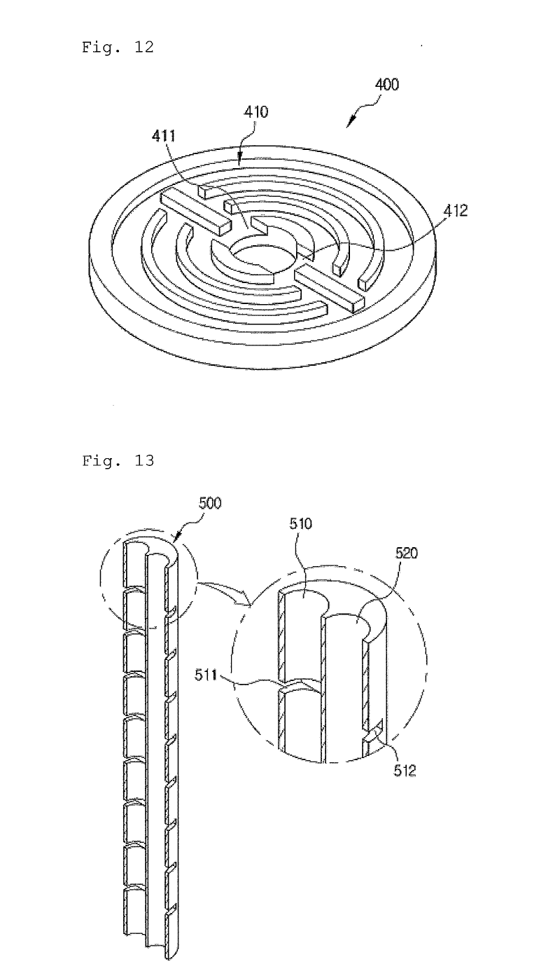

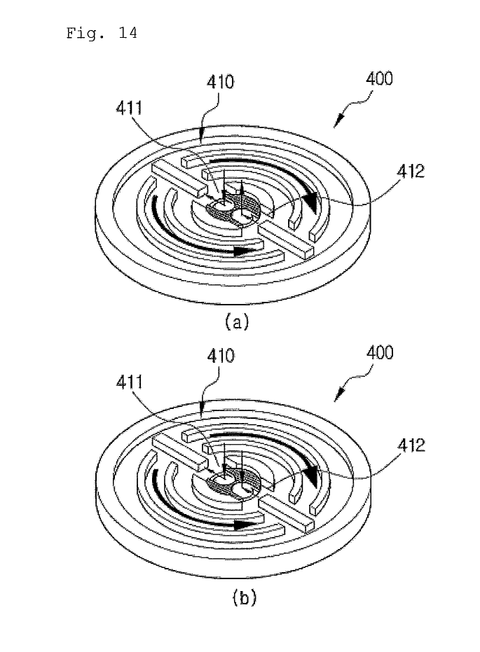

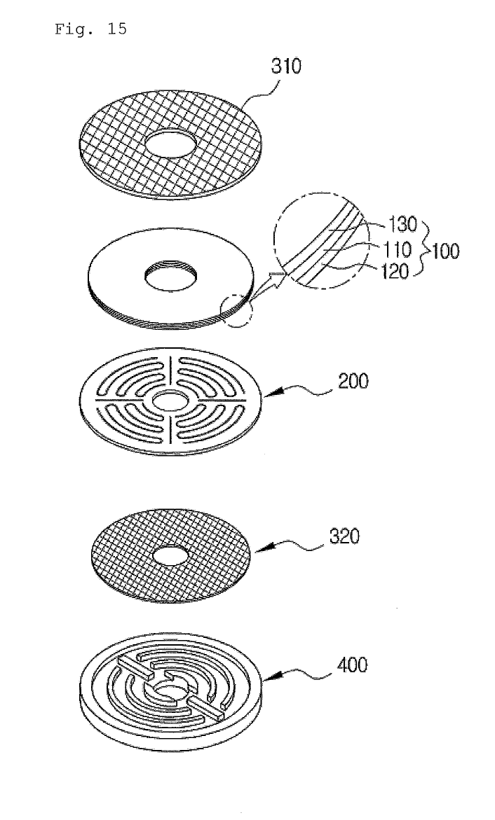

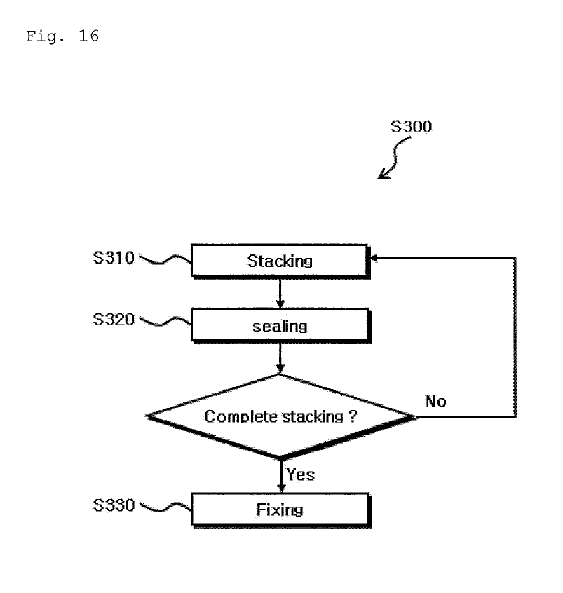

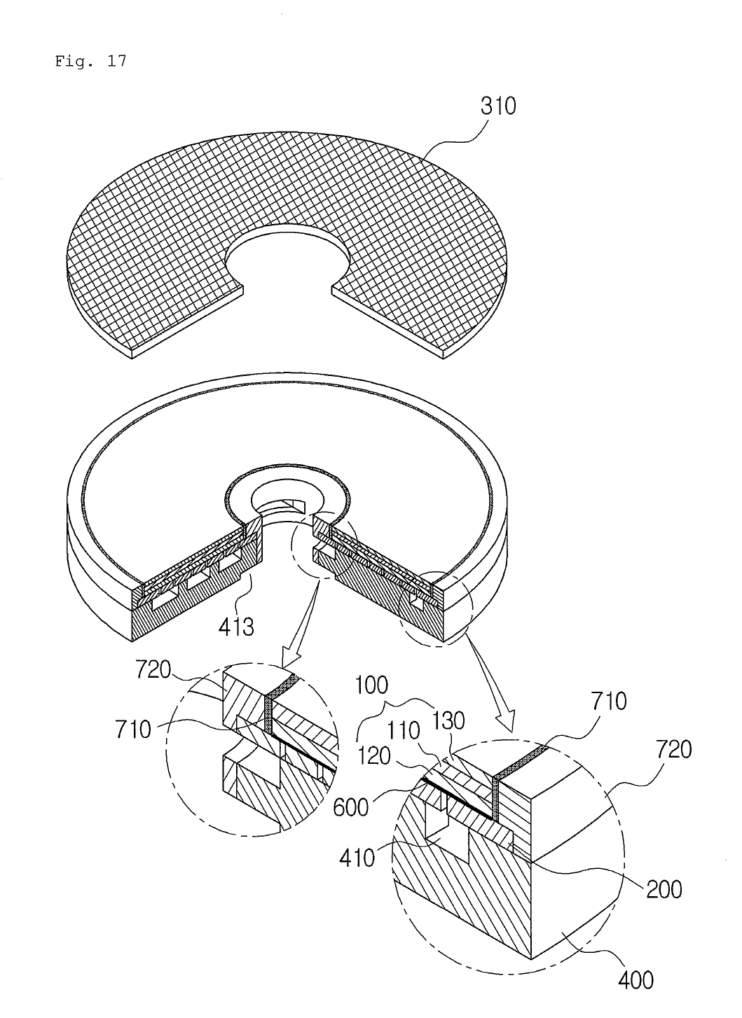

FIG. 2 is a flow chart showing steps in a manufacturing method of a disc type solid oxide fuel cell (SOFC) in accordance with the present invention, FIG. 3 is a flow chart showing other steps in the manufacturing method of the disc type SOFC in accordance with the present invention, FIG. 4 is a view showing a fixing step S400 of a metal supporter 200 in the manufacturing method of the disc type SOFC in accordance with the present invention, FIGS. 5 and 6 are a flow chart and a view showing the fixing step S400 of the metal supporter 200 in the manufacturing method of the disc type SOFC in accordance with the present invention, FIG. 7 is a view showing a fixing step S500 of a metal supporter 200 and a separation plate 400 in the manufacturing method of the disc type SOFC in accordance with the present invention, FIGS. 8 to 10 are a perspective view, an exploded perspective view and a cross-sectional perspective view a disc type SOFC 1000 in accordance with the present invention, FIG. 11 is a view of a metal supporter 200 of the disc type SOFC 1000 in accordance with the present invention, FIG. 12 is a view of a separation plate 400 of the disc type SOFC 1000 in accordance with the present invention, FIG. 13 is a view of a supporting member 500 of the disc type SOFC 1000 in accordance with the present invention, FIG. 14 is a view illustrating a flow of fuel or air in the disc type SOFC 1000 in accordance with the present invention, FIG. 15 is another perspective view showing the disc type SOFC 1000 in accordance with the present invention, FIG. 16 is a flow chart showing an assembling step S300 in the manufacturing method of the disc type SOFC in accordance with the present invention, and FIG. 17 is another perspective view showing the disc type SOFC 1000 in accordance with the present invention.

The present invention relates to a manufacturing method of a disc type solid oxide fuel cell (SOFC) and a disc type SOFC manufactured by the method. Each construction and shape of the SOFC 1000 will be described in the each step of the manufacturing method of the disc type SOFC 1000.

As shown in FIG. 2, a manufacturing method of a SOFC in accordance of the present invention includes a step S100 of forming an electrolyte layer 110 and an anode 120, a step S200 of forming a cathode 130 and an assembling step S300.

In the step S100 of forming the electrolyte layer 110 and the anode 120, the anode 120 is formed at one side of the electrolyte layer 110 forming a part of a unit cell 100. And in the step S200 of forming the cathode 130, the cathode 130 is formed at the other side of the electrolyte layer 110 that the anode 120 is not formed. Therefore, the unit cell 100 is formed by the step S100 of forming the electrolyte layer 110 and the anode 120 and the step S200 of forming the cathode 130.

The assembling step S300 includes a step S310 of stacking a unit cell 100, a first current collecting member 310 and a separation plate 400 on a separate supporting member 500, and a fixing step S330. The supporting member 500 is formed to be elongated in a length direction. The unit cell 100, the first current collecting member 310 and the separation plate 400 are hollowed at center portions thereof and inserted onto the supporting member 500.

The first current collecting member 310 is provided at the side of the unit cell 100 that the cathode 130 is formed. Preferably, the first current collecting member 310 is formed into a porous or mesh type so that fuel or air supplied from an outside is smoothly supplied to the unit cell 100.

The separation plate 400 is provided at the side of the unit cell 100 that the anode 120 is formed, and formed with a passage 410 through which the fuel is flowed, and also formed of an oxidation-resistant metallic material such as STS410, STS430, Inconel, Fe—Cr—Ni and Crofer22. The passage 410 may be formed in mechanical working and cutting, and chemical finishing such as etching and foaming.

The passage 410 formed at the separation plate 400 may be formed into various shapes, but preferably formed so that the fuel is uniformly flowed to the unit cell 100.

FIG. 12 shows an example that the passage 410 of the separation plate 300 is divided into two regions so as to form a plurality of circular passages 410. Further, according to the disc type SOFC 1000 of the present invention, the passage 410 may be formed into various shapes or types by controlling a shape of a protrusion in the separation plate 400.

The supporting member 500 is inserted into the unit cell 100, the metal supporter 200, the first current collecting member 310 and the separation plate 400 so as to support them. The disc type SOFC 1000 of the present invention is manufactured by repeatedly stacking the separation plate 400, the metal supporter 200, the unit cell 100 and the first current collecting member 310 in turn.

The supporting member 500 functions to support the unit cell 100, the first current collecting member 310 and the separation plate 400, and also functions as a fuel supplying and discharging path through which the fuel or air is supplied to the passage 410 of the separation plate 400 and then discharged.

The supporting member 500 has first and second paths 510 and 520 formed in a length direction. The first and second paths 510 and 520 have first and second communicating portion 511 and 512 formed in a transverse direction so as to be communicated with the passage 410 of the separation plate 400 (referring to FIG. 13).

The separation plate 400 has inlet and outlet portions 411 and 412 which are connected with the first and second communicating portions 511 and 512 in order to introduce the fuel or air to the first and second communicating portions 511 and 512.

The inlet and outlet portions 411 and 412 are formed into an open type, and the open type inlet and outlet portions 411 and 412 have to be maintained in the next step (referring to FIG. 12).

As shown in FIG. 3, the manufacturing method of the disc type SOFC further includes a fixing step S400 of the metal supporter 200 between the step S100 of forming the electrolyte layer 110 and the anode 120 and the step S200 of forming the cathode 130, and a fixing step S500 of the metal supporter 200 and the separation plate 400 between the step S200 of forming the cathode 130 and the assembling step S300.

In the fixing step S400 of the metal supporter 200, as shown in FIG. 4, the anode 120 and the metal supporter 200 are fixedly bonded to each other. The metal supporter 200 is bonded to the anode 120 side of the unit cell 100 so as to increase current collecting efficiency and durability of the SOFC 1000.

The metal supporter 200 is also hollowed at a center portion thereof so as to be inserted onto the supporting member 500. The metal supporter 200 has a hollowed portion 210 so that the fuel introduced through the separation plate 400 is supplied to the unit cell 100.

Since one side surface of the metal supporter 200 is bonded with the unit cell 100 and the other side surface thereof is bonded with the separation plate 400, the metal supporter 200 has to have desired mechanical strength and heat resistance sufficient to prevent a deformation upon a bonding process. The metal supporter 200 may be formed of an oxidation-resistant metallic material such as STS410, STS430, Inconel, Fe—Cr—Ni and Crofer22. A type of the metal supporter 200 will be described below.

In the fixing step S400 of the metal supporter 200, the anode 120 and the metal supporter 200 may be sinter-bonded using a bonding material 600. More detailedly, as shown in FIGS. 5 and 6, the fixing step S400 of the metal supporter 200 includes a coating step S410 of a first bonding material 810, a drying step S420, a coating step S430 of a second bonding material 820, and a sinter-bonding step S440.

Since the metal supporter 200 and the anode 120 are respectively formed of a different material, that is, the metal supporter 200 is formed of a metallic material and the anode 120 is formed of ceramic material, bonding force between the metal supporter 200 and the anode 120 may be deteriorated. To solve the problem, the steps S410 to S440 are performed in the fixing step S400 of the metal supporter 200.

In the coating step S410 of the first bonding material 810, the first bonding material 810 is coated at one side of the metal supporter 200. The first bonding material 810 contains metal powder, a material forming the anode 120 and an additive (a pore-forming agent, a solvent, a binder, a plasticizer, a dispersing agent). Preferably, a content of the metal powder is larger than that of the material forming the anode 120.

The metal powder may include AISI410 and a Fe—Cr—Ni-based material, and the material forming the anode 120 may include 8YSZ, NiO, Ce-based electrolyte material and the like.

In the drying step S420, the metal supporter 200 coated with the first bonding material 810 is dried at a room temperature.

In the coating step S430 of the second bonding material 820, the second bonding material 820 is coated at one side of the anode 120. Like the first bonding material 810, the second bonding material 820 contains metal powder, a material forming the anode 120 and an additive (a pore-forming agent, a solvent, a binder, a plasticizer, a dispersing agent). Preferably, a content of the metal powder is larger than that of the material forming the anode 120.

A thickness of each of the first and second bonding materials 810 and 820 is controlled according to a thickness of the metal supporter 200 and the anode 120.

In other words, the first bonding material 810 allows the metal supporter 200 and the anode 120 to be facilely bonded by the second bonding material 820. The metal supporter 200 and the anode 120 are fixedly bonded to each other through the sinter-bonding step S440.

In the sinter-bonding step S440, after the coating step S430 of the second bonding material 820 but before the second bonding material 820 is dried, the side of the metal supporter 200 on which the first bonding material 810 is coated and dried is closely contacted with the side of the anode 120 on which the second bonding material 820 is coated, and then they are sintered for 2˜10 hours at a temperature of 1300˜1450° C.

When the unit cell 100 is sintered in the prior art, if a bonding surface is so wide, there is the danger of deforming the unit cell 100. However, in the disc type SOFC according to the present invention, since the center portions of the unit cell 100 and the metal supporter 200 are hollowed to be inserted and stacked onto the supporting member 500, it is possible to minimize a deformation risk of the unit cell 100.

At this time, the metal supporter 200 has a circular shape in section, and also has a hollowed portion 210 which is variously formed therein. The metal supporter 200 as shown in FIG. 11a has the hollowed portion 210 which is continuously formed at each of four partitioned spaces. For example, the hollowed portion 210 formed at each space is formed into a Z-shape that a part of a circumference thereof is continuously connected so as to be facilely communicated with the passage 410 of the separation plate 400.

Alternatively, the metal supporter 200 of FIG. 11b has the Z-shape hollowed portion 210 which is continuously formed at each of four partitioned spaces to be perpendicular to a diameter of the metal supporter 200.

The hollowed portion 210 of the metal supporter 200 may be formed into various shapes. However, the hollowed portion 210 is formed only within a region bonded with the unit cell 100 so that the fuel or air flowed through the passage 410 of the separation plate 400 is smoothly supplied to the unit cell 100. Preferably, the passage 410 of the separation plate 400 and the hollowed portion 210 of the metal supporter 200 are formed to be up and downwardly connected with each other so that the fuel or air is smoothly supplied to the unit cell 100.

The fixing step S500 of a metal supporter 200 and a separation plate 400 is performed between the step S200 of forming the cathode 130 and the assembling step S300. In the step S500, the side of the metal supporter 200 that the unit cell 100 is fixed is bonded with a circumference of the side of the separation plate 400 that the passage 410 is formed so as to enhance the sealing ability.

A fixing method in the fixing step S500 of the metal supporter 200 and the separation plate 400 is welding. In the present invention, the welding includes brazing as well as laser welding, argon welding and so on.

When welding the metal supporter 200 and the separation plate 400, the first and second communicating portions 511 and 512 through which the fuel is flowed have to be maintained in an opened state.

Due to the performing of the fixing step S500 of the metal supporter 200 and the separation plate 400, the manufacturing method of the disc type SOFC 1000 of the present invention solves a problem that the fuel is leaked and thus energy generation efficiency is reduced.

The fixing step S500 of the metal supporter 200 and the separation plate 400 may be performed, after the second current collecting member 320 is provided between the metal supporter 200 and the separation plate 400, so as to further improve the current collecting efficiency (referring to FIG. 15).

In case that the second current collecting member 320 is further provided, the separation plate 400 has an internally stepped portion at the side thereof, which is bonded with the metal supporter 200, so as to form a space in which the second current collecting member 320 is provided.

In the manufacturing method of the disc type SOFC of the present invention, preferably, the separation plate 400, the metal supporter 200, the unit cell 100 and the first current collecting member 310 have a circular shape in section, respectively, and this shape allows the stacking to be facile and also allows the fuel or air supplied through the supporting member 500 to be smoothly flowed over the entire region.

According to the manufacturing method of the disc type SOFC the present invention as described above, it is possible to facilely design the flow the fuel or gas and simplify the structure thereof, thereby making the stacking easy.

Further, in the manufacturing method of the disc type SOFC of the present invention, since it is possible to repeatedly stack the separation plate 400, the metal supporter 200, the unit cell 100 and the first current collecting member 310 in turn, the assembling step S300 further includes a sealing step S320 between the stacking step S310 and the fixing step S330. The stacking step S310 and the sealing step S320 may be repeatedly performed according to the number of stacking steps (referring to FIG. 16).

In the sealing step S320, a hollowed region which is formed at an upper side of the first current collecting member 310 to be contacted with the supporting member 500 is sealed by a sealing material 710.

Thus, it is possible to enhance the sealing ability, thereby preventing the fuel and the air, and also it is possible to further increase the energy generation efficiency.

Preferably, in order to receive a volume of the sealing material 710, an internally stepped portion 413 is formed at a lower side of the separation plate 400 to be adjacent to the hollowed region.

As shown in FIG. 17, in the manufacturing method of the disc type SOFC of the present invention, a sealing disc 720 may be further provided at the sealed portion.

In FIG. 17, for example, the sealing disc 720 may be provided at two places so as to enclose a hollowed center region and an outer circumference.

The sealing disc 720 may be formed into various shapes or types. The sealing disc 720 provided at the hollowed center region of FIG. 17 has a stepped inner surface so as to enclose the unit cell 100, the metal supporter 200 and the separation plate 400. Herein, the sealing disc 720 is formed so as not to block the passage 410 of the separation plate 400.

In order to enhance the sealing ability of the sealing disc 720, the sealing material 710 may be further provided between the sealing disc 720 and the unit cell 100. Sealant may be used as the sealing material 710.

FIG. 17 shows an example that the sealing disc 720 formed at an outer circumference encloses the unit cell 100 and the metal supporter 200, wherein the sealing disc 720 is provided at each of the center region and the outer circumference, and the sealing material 710 is provided between the sealing disc 720 and the unit cell 100.

As shown in FIG. 17, the sealing disc 720 formed at the center region and the outer circumference may be formed into a plate type ring-shaped member according to shapes of the unit cell 100, the metal supporter 200 and the separation plate 400. Also, the sealing disc 720 may be provided at one of the center region and the outer circumference.

Meanwhile, a disc type SOFC 100 of the present invention is manufacture by the above-mentioned method.

According to the flow of the fuel and air in the disc type SOFC 100 of the present invention, the fuel is flowed to the passage 410 through the first path 510 and the first communicating portion 511 of the supporting member 500 and the inlet portion 411 of the separation plate 400, and then discharged through the outlet portion 412 of the separation plate 400 and the second communicating portion 512 and the second path 520 of the supporting member 500. And the air is supplied from an outside.

FIG. 14 shows an example of the flow of the fuel or air circulating in the passage 410 of the separation plate 400. More detailedly, in FIG. 14a, the fuel or air is flowed from an upper side to a lower side through the first path 510, and moved in the transverse direction through the first communicating portion 511 and the inlet portion 411, and divided into left and right passages 410, and then moved to the second passage 520 through the outlet portion 412 and the second communicating portion 512, and moved from the lower side to the upper side through the second path 520.

In FIG. 14b, the fuel or air is flowed in the same manner as in FIG. 14a, but the fuel or air in the second path 520 is flowed reversely (from the upper side to the lower side).

According to the disc type SOFC 1000 of the present invention, the fuel or air may be flowed to be symmetrical in up and down and left and right directions.

Since the separation plate 400 has to be fixed so that the inlet and outlet portions 411 and 412 are communicated with the first and second communicating portions 511 and 512 of the supporting member 500, there may be provided a height forming member (not shown) for deciding an initial stacking position.

The height forming member may be formed into a bolt shape that a screw thread is formed at an inner surface thereof, and an outer surface of the supporting member 500 may be formed to be corresponding to the inner surface of the height forming member.

The height forming member may have various shapes so as to decide a position thereof at a lower side, and may be fixed by its own weight. Alternatively, other member having the same shape as the bolt type height forming member may be coupled to the upper supporting member 500.

According to the manufacturing method of the disc type SOFC 1000 of the present invention as described above, since each construction element is hollowed at its center portion and stacked to be supported by the separate supporting member, it is possible to facilitate the stacking, minimize a size of the fuel cell and also stably enhance the energy generation efficiency.

Further, since each construction element is formed to have a circular shape in section and the unit cell and the metal supporter are sinter-bonded, it is possible to increase the sealing efficiency and minimize the deformation of the cell. Also since the metal supporter is bonded to the separation plate, it is possible to provide the sufficient mechanical strength.

Furthermore, since one of the fuel and the air is flowed to the passage of the separation plate through the supporting member and then discharged through the supporting member, and the other is supplied from the outside, it is possible to facilely supply the fuel or air and simplify the structure thereof.

While the present invention has been described with respect to the specific embodiments, it will be apparent to those skilled in the art that various changes and modifications may be made without departing from the spirit and scope of the invention as defined in the following claims.

1. A manufacturing method of a disc type solid oxide fuel cell (SOFC), comprising:
forming an electrolyte layer and an anode which forms a unit cell;
forming a cathode, which forms the unit cell, at one side of the electrolyte layer that the anode is not formed; and
stacking and assembling the unit cell, a first current collecting member provided at a cathode side of the unit cell, and a separation plate which is provided at an anode side of the unit cell and has a separation plate formed with a passage,
wherein the unit cell, the first current collecting member and the separation plate are hollowed at center portions thereof and inserted onto a supporting member.

2. The manufacturing method of claim 1, further comprising fixing the metal supporter to the anode between said forming of the electrolyte layer and the anode and said forming of the cathode.

3. The manufacturing method of claim 2, further comprising fixing a side of the metal supporter that the unit cell is fixed and a circumference of the side of the separation plate that the passage is formed between said forming of the cathode and said stacking and assembling.

4. The manufacturing method of claim 3, wherein the separation plate, the metal supporter, the unit cell and the first current collecting member have a circular shape in section.

5. The manufacturing method of claim 3, wherein the metal supporter has a hollowed portion so that the passage of the separation plate and the unit cell are communicated with each other.

6. The manufacturing method of claim 3, wherein the supporting member has first and second paths formed in a length direction, and the first and second paths have first and second communicating portion formed in a transverse direction so as to be communicated with the passage of the separation plate.

7. The manufacturing method of claim 6, wherein the separation plate has inlet and outlet portions which are connected with the first and second communicating portions.

8. The manufacturing method of claim 2, wherein the anode and the metal supporter are sinter-bonded using a bonding material in said fixing of the metal supporter.

9. The manufacturing method of claim 3, wherein said fixing of the metal supporter comprises:
coating a first bonding material at one side of the metal supporter;
draying the metal supporter coated with the first bonding material;
coating a second bonding material at one side of the anode; and
closely contacting and sinter-contacting a side of the metal supporter that the first bonding material is coated and a side of the anode on which the second bonding material is coated.

10. The manufacturing method of claim 9, wherein said fixing of the metal supporter and the separation plate is performed after a second current collecting member is provided between the metal supporter and the separation plate.

11. The manufacturing method of claim 3, wherein the separation plate, the metal supporter, the unit cell and the first current collecting member are repeatedly stacked, in turn, in said assembling of them.

12. The manufacturing method of claim 11, wherein said assembling of the separation plate, the metal supporter, the unit cell and the first current collecting member in turn comprises:
stacking the separation plate, the metal supporter, the unit cell and the first current collecting member;
sealing a hollowed region, which is formed at an upper side of the first current collecting member to be contacted with the supporting member, using a sealing material; and
fixing the separation plate, the metal supporter, the unit cell and the first current collecting member,
wherein said stacking and said sealing are repeatedly performed according to the number of stackings.

13. The manufacturing method of claim 12, wherein a sealing disc is further provided in said stacking of said assembling.

14. The manufacturing method of claim 13, wherein an internally stepped portion is formed at a lower side of the separation plate to be adjacent to a hollowed region, thereby receiving a volume of the sealing material.

15. A disc type SOFC manufacture by the manufacturing method of claim 1.

16. The disc type SOFC of claim 15, wherein fuel introduced through the first path and the first communicating portion of the supporting member and the inlet portion of the separation plate is flowed along the passage, and then discharged through the outlet portion of the separation plate and the second communicating portion and the second path of the supporting member, and air is supplied from an outside.
